(19) United States
(12) Patent Application Publication
(10) Pub. No.: US 2022/0299446 A1
(43) Pub. Date: Sep. 22, 2022

(54) CALIBRATION OF SENSORS FOR ROAD SURFACE MONITORING

(71) Applicant: RoadCloud Oy, Espoo (FI)

(72) Inventors: Ari TUONONEN, Espoo (FI); Arto NISKANEN, Espoo (FI); Mikko SYRJÄLAHTI, Espoo (FI)

(73) Assignee: RoadCloud Oy, Espoo (FI)

(21) Appl. No.: 17/635,562

(22) PCT Filed: Aug. 31, 2020
(86) PCT No.: PCT/FI2020/050561

§ 371 Date: Feb. 15, 2022

(30) Foreign Application Priority Data
Sep. 11, 2019 (FI) 20195751

(51) Int. Cl. G01N 21/93; G01N 21/55; G01N 21/89

(52) U.S. Cl. CPC G01N 21/93; G01N 21/55; G01N 21/89; G08G 1/096766

(57) ABSTRACT

An apparatus and a method including, receiving by a server, from a first vehicle, a first optical measurement result of a surface of a road, wherein the first optical measurement result is associated with a first location of the road, receiving by the server, from a second vehicle, a second optical measurement result of the surface of the road associated with the first location of the road and calibrating a sensor of the second vehicle at the server based on a difference between the first and the second optical measurement results associated with the first location of the road.

### FIELD

Various example aspects of the disclosed embodiments relate in general to calibration of sensors and more specifically, to calibration of sensors for road surface monitoring.

### BACKGROUND

In general, calibration refers to comparing a measurement result of a measuring apparatus, such as a sensor, to a reference value. A difference between the measurement result of the measuring apparatus and the reference value may be then used for adjusting operation of the measuring apparatus. Calibration may be thus used for determining and improving accuracy of the subsequent measurement results. However, measurement results of the measuring apparatus may start to drift from reference values if calibration is not repeated regularly.

Road surface may be monitored for weather and mechanical conditions, such as moisture, ice, snow, temperature, humidity and/or roughness. Information related to weather and mechanical conditions may be used for road maintenance, autonomous driving, weather services and for other purposes. Road surface monitoring may be done using fixed monitoring stations, for example using sensors and cameras looking at the road from the side of the road and/or sensors embedded into the road. Calibration of fixed monitoring stations may be performed easily as the same reference value, from the same reference point, may be used for the same location under the same conditions.

In case of mobile monitoring stations, such as sensors mounted on a vehicle, calibration cannot be performed as easily as the time and location of measurements may change. Nevertheless, calibration of sensors of vehicles is required at least every now and then to ensure that the measurement results provide accurate information. Mobility of the vehicles is often an issue though, because the environment and circumstances may change and thus it is not possible to use only one reference point for calibrating one vehicle. Therefore, there is a need to provide improved methods, apparatuses, and computer programs for calibration of sensors of vehicles.

### SUMMARY

According to some aspects, there is provided the subject-matter of the independent claims. Some embodiments are defined in the dependent claims.

According to a first aspect of the present disclosure, there is provided an apparatus comprising a receiver configured to receive from a first vehicle a first optical measurement result of a surface of a road, wherein the first optical measurement result is associated with a first location of the road, and to receive from a second vehicle a second optical measurement result of the surface of the road associated with the first location of the road, and at least one processor configured to calibrate a sensor of the second vehicle at the apparatus based on a difference between the first and the second optical measurement results.

The at least one processor may be further configured to determine that the first optical measurement result associated with the first location of the road has been taken at known conditions of the surface of the road at the first location and set, responsive to the determination, the first optical measurement result associated with the first location of the road as a reference measurement result of the first location.

The at least one processor may be further configured to determine a background of the road at the first location based on the first optical measurement result associated with the first location of the road and calibrate the sensor of the second vehicle based at least partially on the determined background of the road at the first location.

The at least one processor may be further configured to determine a road surface classification of the first optical measurement result associated with the first location and calibrate the sensor of the second vehicle based at least partially on the road surface classification of the first optical measurement result associated with the first location.

The at least one processor may be further configured to determine a difference between a road surface classification of the first optical measurement result associated with the first location and a road surface classification of the second optical measurement associated with the first location, and calibrate the sensor of the second vehicle based at least partially on the difference between the road surface classification of the first optical measurement result associated with the first location and the road surface classification of the second optical measurement result associated with the first location.

The receiver may be further configured to receive, from a third vehicle, a third optical measurement result associated with the first location and the at least one processor may be further configured to calibrate the sensor of the second vehicle based at least partially on the first, the second and the third optical measurement results associated with the first location.

The at least one processor may be further configured to determine a difference between a road surface classification of the first optical measurement result associated with the first location and a road surface classification of the third optical measurement result associated with the first location and calibrate the sensor of the second vehicle by compensating for the difference between the road surface classification of the first optical measurement result associated with the first location and the road surface classification of the third optical measurement result associated with the first location. The road surface classification of the first optical measurement result may be dry and the road surface classification of the third optical measurement result may be wet.

The at least one processor may be further configured to calibrate the sensor of the second vehicle based at least partially on a difference between a weather at the first location at a time of the first optical measurement result associated with the first location and a weather at the first location at a time of the second optical measurement result associated with the first location.

The receiver may be further configured to receive weather information from a weather station and the at least one processor may be configured to determine, based on the received weather information, the weather at the first location at a time of the first optical measurement associated with the first location and the weather at the first location at a time of the second optical measurement associated with the first location.

The receiver may be further configured to receive from the second vehicle, upon calibration of the sensor of the second vehicle, a first optical measurement result associated with a second location and to receive from a fourth vehicle a second optical measurement result associated with the second location, and the at least one processor may be further configured to calibrate a sensor of the fourth vehicle based on a difference between the first and the second optical measurement results associated with the second location.

The at least one processor may be further configured to dispose the second optical measurement result upon determining that a difference between a time of the first optical measurement result and a time of the second optical measurement result is above a first threshold value, and/or a difference between a value of the first optical measurement result and a value of the second optical measurement result is above a second threshold.

The at least one processor may be further configured to dispose the second optical measurement result upon determining that a background of the road associated with the first optical measurement result and a background of the road associated with the second optical measurement result are different.

According to a second aspect of the present disclosure, there is provided a method comprising receiving by a server, from a first vehicle, a first optical measurement result of a surface of a road, wherein the first optical measurement result is associated with a first location of the road, receiving by the server, from a second vehicle, a second optical measurement result of the surface of the road associated with the first location of the road and calibrating a sensor of the second vehicle at the server based on a difference between the first and the second optical measurement results associated with the first location of the road.

According to a third aspect of the present disclosure, there is provided a non-transitory computer readable medium having stored thereon a set of computer readable instructions that, when executed by at least one processor, cause an apparatus to at least perform the method.

According to a fourth aspect of the present disclosure, there is provided a computer program configured to perform the method.

### BRIEF DESCRIPTION OF THE DRAWINGS

FIG. 1 illustrates a first exemplary scenario in accordance with at least some embodiments of the present disclosure;

FIG. 2 illustrates measuring in accordance with at least some embodiments of the present disclosure;

FIG. 3 illustrates a second exemplary scenario in accordance with at least some embodiments;

FIG. 4 illustrates a third exemplary scenario in accordance with at least some embodiments;

FIG. 5 illustrates a fourth exemplary scenario in accordance with at least some embodiments;

FIG. 6 illustrates an example apparatus capable of supporting at least some embodiments of the present disclosure; and

FIG. 7 illustrates a flow graph of a method in accordance with at least some embodiments of the present disclosure.

### EMBODIMENTS

Embodiments of the present disclosure relate to road surface monitoring. More specifically, embodiments of the present disclosure relate to mobile optical measurements of road surface. In some embodiments, optical measurements may be done using a sensor mounted on a vehicle. Said optical measurements may be performed in various locations at different times, and properties of the road surface may change depending on time and location. For instance, different lanes and road sections may have different asphalt or the road surface may wear out, thereby changing the properties of the road surface at that location.

Various issues affect the accuracy of optical measurements though. For instance, calibration of sensors is needed for performing accurate optical measurements because without regular calibration and adjustment, measurement results of sensors may start drifting from reference values. Additionally, sensors, i.e., optics of sensors, may get dirty under field conditions and hence affect the accuracy of the optical measurements.

Embodiments of the present disclosure therefore enable calibration of sensors for mobile optical measurements, such as for optical measurements of sensors of vehicles. Calibration may be performed by an apparatus, such as a server or a cloud server. The apparatus may for instance receive from a first vehicle a first optical measurement result of a surface of a road, the first optical measurement result being associated with a certain location of the road, and determine that the first optical measurement result may be used as a reference value for calibrating a sensor of a second vehicle at the same location.

Calibration may be done at the apparatus. That is to say, the apparatus may store a difference between the first optical measurement result and a second optical measurement result received from the second vehicle, the second optical measurement result being associated with the same location as the first optical measurement result. The apparatus may then use the difference between the first and the second optical measurement results to adjust subsequent measurement results received from the second vehicle, possibly without transmitting any information about calibration back to the second vehicle. Said adjusted measurement results may then be used for generating an overall picture of the surface of the road. In general, a measurement result may refer to a value of a measurement result, such as an intensity of a reflected signal.

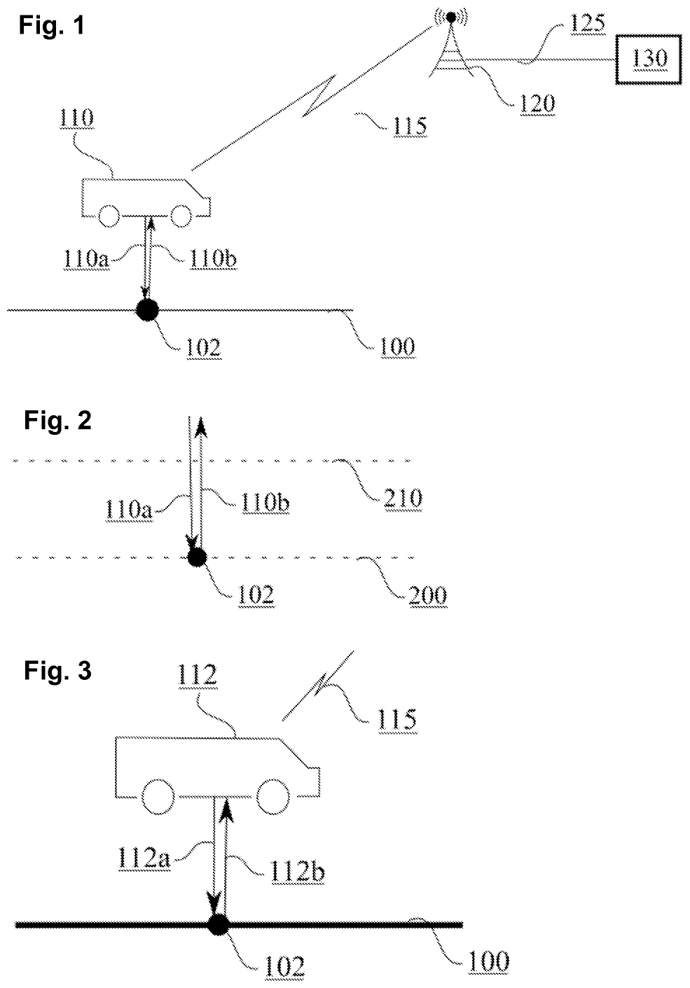

FIG. 1 illustrates a first exemplary scenario in accordance with at least some embodiments of the present disclosure. The exemplary scenario of FIG. 1 may comprise a road 100, a first vehicle 110, such as a car or a motorcycle, a Base Station, BS, 120, and an apparatus 130, such as a server or a cloud server. The first vehicle 110 may comprise a mobile terminal, for example, a smartphone, a cellular phone, a Machine-to-Machine, M2M, node, Machine-Type Communications node, MTC, an Internet of Things, IoT, node, a car telemetry unit, a laptop computer, a tablet computer or, indeed, any kind of suitable mobile wireless terminal or station. The first vehicle 110 may further comprise at least one sensor, such as an optical sensor capable of performing optical measurement of a surface of road 100. For instance, if the mobile terminal of the first vehicle 110 is an IoT node, the IoT node may comprise said at least one sensor of the first vehicle 110.

An example of an optical measurement is optical absorbance using illumination specific wavelengths to determine moisture, water, ice, and snow on the road 100. For such a measurement one may use laser or Light-Emitting Diode, LED, illumination at Short-Wave Infrared, SWIR, wavelengths, or other suitable wavelengths, and measure the reflected and/or backscattered light from the surface of road 100. Alternatively, one can use wideband illumination with spectrally selective measurements. Examples of commercially available optical sensors are Road Eye from Optical Sensors Sweden AB, RCM411 from Teconer Oy, Finland and IceSight 2020E from Innovative Dynamics Inc. (Ithaca, N.Y., USA) IVS optical from Intelligent Vision Systems, Dexter, Mich., USA).

Moreover, said at least one sensor may be connected, or incorporated, to the mobile terminal of the first vehicle 110, thereby enabling transmission of optical measurements from the at least one sensor of the first vehicle 110 to the apparatus 130 via the mobile terminal of the first vehicle 110 and the BS 120. Alternatively, in case of V2V communications for example, the mobile terminal of the first vehicle 110 may be connected to another vehicle, or a mobile terminal of said another vehicle, and the optical measurement results may be transmitted from the at least one sensor of the first vehicle 110 to said another vehicle. Said another vehicle, or a mobile terminal of said another vehicle, may possibly forward the optical measurement results received via V2V communications, to the apparatus 130 via the BS 120. Also, in some embodiments, sensors of the first vehicle 110 may communicate with each other or forward optical measurement results of other sensors of the first vehicle 110.

An air interface 115 between the mobile terminal of the first vehicle 110 and the BS 120 may be configured in accordance with a Radio Access Technology, RAT, which the mobile terminal of the first vehicle 110 and BS 120 are configured to support. The mobile terminal of the first vehicle 110 may communicate with the BS 120 via the air interface 115 using the RAT. Examples of cellular RATs include Long Term Evolution, LTE, New Radio, NR, which may also be known as fifth generation, 5G, radio access technology and MulteFire. For instance, in the context of LTE, a BS may be referred to as eNB while in the context of NR, a BS may be referred to as a gNB. On the other hand, examples of non-cellular RATs include Wireless Local Area Network, WLAN, and Worldwide Interoperability for Microwave Access, WiMAX. For example, in the context of WLAN, the BSs may be referred to as access points.

In any case, embodiments are not restricted to any particular wireless technology. Instead, embodiments may be exploited using any wireless communication system which enables communication between the mobile terminal of the first vehicle 110 and the BS 120. That is to say, for example optical measurement results may be transmitted and received via a communication network in general.

Moreover, the BS 120 may be connected, directly or via at least one intermediate node, with the apparatus 130 via an interface 125. The interface 125 may be a wired interface. For instance, the BS 120 and the apparatus 130 may be connected via an interface with another network (not shown in FIG. 1), via which connectivity to further networks may be obtained, for example via a worldwide interconnection network.

The first vehicle 110 may move on the road 100, i.e., the first vehicle 110 may be driven on the road 100. Alternatively, the first vehicle 110 may drive itself on the road 100 if the first vehicle 110 is for example a self-driving car, i.e., an autonomous car, driverless car, or robotic car. At a first location 102, a first optical measurement may be performed by the at least one sensor of the first vehicle 110 to generate a first optical measurement result. The first optical measurement result may be transmitted from the at least one sensor of the first vehicle 110 to apparatus 130, e.g., via the mobile terminal of the first vehicle 110 and the BS 120. Measuring may comprise transmitting a measurement signal 110a at the first location 102 and a receiving reflected version 110b of the measurement signal. In general, a location in accordance of at least some embodiments of the present disclosure, such as the first location 102, may refer to a road segment. That is to say, the location may refer to a point on the road 100 or a segment on the road 100.

Upon receiving the first optical measurement result, the apparatus 130 may determine that the first optical measurement result has been taken at known conditions of a surface of the road 100 and set the first optical measurement result as a reference measurement result for the first location 102.

In some embodiments, the apparatus 130 may determine a background of the road 100 at the first location 102. For instance, the apparatus 130 may determine that the background of the road 100 at the first location 102 is black asphalt, white asphalt, or concrete. Apparatus 130 may determine the background of road 100 at the first location 102, e.g., based on information received from a database and/or based on the first optical measurement result. For instance, the apparatus 130 may transmit, upon receiving the first optical measurement result, a request to the database to request the background of the road 100 at the first location 102. Responsive to the request, the apparatus 130 may receive from the database information indicating that the background of the road 100 is black asphalt for example.

In some embodiments, a background of the road 100 may refer to a response and/or emissivity of electromagnetic signals related properties of the surface of the road 100. Also, if measuring a thickness of a layer of water on the road 100, for example, the background of road 100 may refer to the road 100 itself, i.e., the road 100 may be seen as the background of the road 100.

Alternatively, or in addition, the apparatus 130 may determine a road surface classification of the road 100 associated with, or of, the first optical measurement result. The road surface classification associated with the first optical measurement result may be specifically linked to the first location 102. For instance, the apparatus 130 may determine that the road surface classification of the first optical measurement is dry, wet, or icy. The road surface classification associated with the first optical measurement result may be determined based on the determined background of the road 100. If the background of road 100 is black asphalt for example, the apparatus 130 may determine that the road surface classification of the first optical measurement is dry if the first optical measurement result indicates that a power of the reflected version 110b of the measurement signal is higher than a threshold, because for example wet asphalt attenuates the signal more than dry asphalt.

In some embodiments, the road surface classification of the road 100 may be referred to as a data set for example, wherein one road surface classification set (i.e., one data set) is named as ice or dry asphalt. Nevertheless, in some embodiments, data may be clustered statistically without naming a set specifically. For instance, the one road surface classification set may be named as a data set 1 and then one or more properties, i.e., features, may be associated with said data set 1. Said one or more properties may comprise for example friction, thereby enabling estimation of friction by clustering data, even though the associated data set cannot, or could not, be named/classified.

The road surface classification associated with the first optical measurement result may be linked to a time when the first optical measurement result was taken. Thus, in some embodiments, a time stamp about the time when the first optical measurement result was taken may be transmitted from the mobile terminal of the first vehicle 110 to the apparatus 130 together with the first optical measurement result.

FIG. 2 illustrates measuring in accordance with at least some embodiments of the present disclosure. With reference to FIG. 1, when measuring properties of the surface of the road 100 of FIG. 1, typically there are multiple phenomena affecting the measurement wavelength. In FIG. 2, the surface of the road 100 of FIG. 1 is denoted by 200 and layer of water is denoted by 210.

As an example, when measuring a layer of water 210 on top of the road surface 200, a measurement signal 110a, such as light, may pass through the layer of water 210. Then, the measurement signal 110a may reflect and scatter from the road surface 200 and pass again through the layer of water 210, thereby generating the reflected version 110b of the measurement signal. The reflected version of the measurement signal 110b may be received by the at least one sensor of the first vehicle 110. In some embodiments, a goal may be to measure water absorbance for example and therefore reflection and scatter properties of the road surface 200 may need to be compensated for.

In some embodiments, the measurements related to ice or water may be performed actively as shown in FIG. 2, i.e., using the measurement signal 110a to actively illuminate the surface at location 102. On the other hand, in some embodiments, measurements may be performed passively by using existing illumination, i.e., the object itself may radiate to generate a signal that may be used as a measurement result. An example of a passive measurement is an infrared temperature measurement, where the infrared radiation from a vehicle, such as the first vehicle 110, is the illumination 110a and the goal is to determine the emission, i.e., the measurement signal 110b, from the road surface 200 while taking into account the possible extra layer, such as the layer of water 210, and local properties of the road surface 200, to compensate for reflected illumination 110a. That is to say, in case of passive measurements, the road surface 200 is not actively illuminated.

In some embodiments, the measuring may comprise measuring with at least two different wavelengths. For instance, if measurements are performed using a first wavelength and a second wavelength, the measurement result may comprise one measurement result associated with a first wavelength and another measurement result associated with a second wavelength.

Spectral measurements may be done using multiple wavelengths and calculating different ratios between the measurements. Hence, a stable background reflectance change may be removed by selecting suitable wavelengths. As an example, selecting one wavelength, e.g., the first wavelength, such that the reflected intensity does not change from the parameter being measured and one wavelength, e.g., the second wavelength, such that the reflected intensity changes with the measured parameter, the effects that attenuate both wavelengths may be removed equally.

In a static location, the road surface 200 is typically known or may be measured under known conditions. Consequently, it may be possible to compensate for a background of the road 100. As an example, the at least one sensor of the first vehicle 110 may measure the road surface 200 when the road surface 200 is dry, i.e., the road surface classification of the road 100 of FIG. 1 is dry, and use the measured information later for compensating subsequent measurement results. However, in case of mobile optical measurements, the road surface classification of the road 100 of FIG. 1 at the time of the measurement may not be known and cannot be measured under known conditions.

In some embodiments, the road surface 200 may be measured using the optical measurements with visible and infrared wavelengths. For instance, active measurements may illuminate the road surface 200 using a source like laser, lamp, or LED. Thus, the reflected/absorbed light may be measured to determine a measurement result, e.g., the reflected version 110b of the measurement signal. Alternatively, passive optical measurements may use existing illumination like other lamps, sunlight, or thermal emission of the road surface 200.

FIG. 3 illustrates a second exemplary scenario in accordance with at least some embodiments. FIG. 3 shows the second vehicle 112 moving on the road 100 of FIG. 1. The second vehicle 112 may be similar as the first vehicle 110, i.e., the second vehicle 112 may comprise for example at least one sensor, such as an optical sensor capable of performing optical measurements, and a mobile terminal. The second vehicle 112 may move on the road 100 similarly to the first vehicle 110 and at the location 102 a second optical measurement may be performed by the at least one sensor of the second vehicle 112 to generate a second optical measurement result.

Measuring may comprise transmitting a measurement signal 112a at the location 102 and receiving the reflected version 112b of the measurement signal. The second optical measurement result may be transmitted from the at least one sensor of the second vehicle 110 to the apparatus 130, e.g., via the mobile terminal of the second vehicle 112 and the BS 120. The mobile terminal of the second vehicle 112 may be similar as the mobile terminal of the first vehicle 110. In some embodiments, a time stamp about the time when the second optical measurement result was taken may be transmitted from the mobile terminal of the second vehicle 112 to the apparatus 130 together with the second optical measurement result.

Upon receiving the second optical measurement result, the apparatus 130 may determine that the first optical measurement result and the second measurement result are associated with the same location, i.e., the location 102. If the first and the second measurement results are from the same location, the first optical measurement result may be used as a reference measurement result for calibrating the at least one sensor of the second vehicle 112. The apparatus 130 may also determine that the second optical measurement result is not the reference measurement result and compute, upon determining that the second optical measurement result is not the reference measurement result, a compensation parameter for calibration of the at least one sensor of the second vehicle 112.

Thus, apparatus 130 may calibrate the at least one sensor of the second vehicle 112, e.g., by determining a difference between the first and the second optical measurement results associated with the location 102. The difference between the first and the second optical measurement results associated with the location 102 may be referred to as a compensation parameter as well. So if additional, subsequent measurement results associated with the location 102 are received from the at least one sensor of the second vehicle 112, the apparatus 130 may adjust said additional, subsequent measurement results by the difference between the first and the second optical measurement results associated with the location 102.

Calibration may be performed separately for separate sensors or different wavelengths. For example, one or more (e.g., two) wavelengths may first be compared for calibrating respective sensors. Subsequently, other one or more (e.g., two) wavelengths may be compared for calibrating sensors using those wavelengths. This subsequent comparison may be based on measurements made by entirely different two or more vehicles. Alternatively, given vehicle, say vehicle B, may act as one of the two or more vehicles testing a first set of measurements with respective wavelengths (e.g., frequencies f₁ and f₂) together with vehicle A, and again act as one of the two or more vehicles testing a second set of measurements with respective wavelengths (e.g., frequencies f₃ and f₄) together with vehicle C. Or, vehicles A and B may contribute to calibration of the first set of frequencies, vehicles C to W and Y may not contribute at all, and vehicles X and Z may contribute to calibration of the second set of frequencies. In this example, alphabetical order is used to help explaining one example of potential ways to arrange the calibration.

Calibration of the at least one sensor of the second vehicle 112 may be done at the apparatus 130. That is to say, the apparatus may not provide any information about the calibration to the second vehicle 112. For instance, calibration of the at least one sensor of the second vehicle 112 by the apparatus 130 may comprise storing the difference between the first and the second optical measurement results, possibly to a memory of the apparatus 130, and retrieving the difference in response to receiving an additional, subsequent measurement result from the second vehicle 112. After retrieving the difference between the first and the second optical measurement results, the apparatus 130 may use the difference by adjusting the additional, subsequent measurement result by the difference, to get a calibrated version/value of the additional, subsequent measurement results. The calibrated version/value may be then used by the apparatus 130 to generate an overall picture of the road surface 200, i.e., the surface of the road 100.

In some embodiments, use of the first optical measurement result as a reference measurement result for calibrating the at least one sensor of the second vehicle 112 may depend on a time between the first and the second optical measurement. For instance, if it is determined by the apparatus 130 that the first and the second optical measurement have been taken substantially at the same time, i.e., a difference between a time of the first optical measurement and the second optical measurement is below a threshold, the first optical measurement result may be used as the reference measurement result for calibrating the at least one sensor of the second vehicle 112. The threshold may be for example 5 or 30 minutes. On the other hand, if the difference between the time of the first optical measurement and the second optical measurement is above the threshold, the first optical measurement result may not be used as the reference measurement result for calibrating the at least one sensor of the second vehicle 112.

In some embodiments, the at least one sensor of the second vehicle 112 may be calibrated based on a determined background of the road 100 at the location 102. The background of the road 100 at the location 102 may be determined by the apparatus 130 based on the first optical measurement result and then used for the calibration. That is to say, apparatus 130 may calibrate the at least one sensor of the second vehicle 112 by compensating for the background of the road 100 at the location 102. So if the background of the road 100 at the location 102 was determined as black asphalt for example, a value associated with black asphalt may be taken into account when calibrating the at least one sensor of the second vehicle 112 based on the determined background of the road 100 at the location 102. As an example, if reflection coefficients from location the 102 at 980/1310/1550 nm wavelengths are 0.0033/0.01/0.09 according to the at least one sensor of the first vehicle 110, the at least one sensor of the second vehicle 112 may be compensated to give the same values by calculating suitable compensation factors when the same location, e.g., the location 102, has been measured by both sensors.

Alternatively, or in addition, the apparatus 130 may determine the road surface classification of the road 100 associated with, or of, the second optical measurement result similarly as the road surface classification of the road 100 of the first optical measurement result may be determined. The at least one sensor of the second vehicle 112 may be calibrated based on the determined road surface classification of the road 100 at the location 102. That is to say, the apparatus 130 may calibrate the at least one sensor of the second vehicle 112 by compensating for the road surface classification of the road 100 associated with the first optical measurement result and the road surface classification of road 100 associated with the second optical measurement result at the location 102.

So if the for example the road surface classification of the road 100 associated with the first optical measurement result was determined as dry and the road surface classification of the road 100 associated with the second optical measurement result was determined as wet, a difference between a value associated with dry and a value associated with wet may be taken into account when calibrating the at least one sensor of the second vehicle 112, i.e., calibration may be done based on the determined the road surface classifications of the first and the second optical measurement results at the location 102.

In some embodiments, a third vehicle (not shown in FIG. 2) may also perform measurements at the location 102 to create a third optical measurement result associated with the location 102, for example before the second optical measurement result has been received by the apparatus 130. The apparatus 130 may determine that the third optical measurement result has been taken under known conditions as well. Thus, the apparatus 130 may exploit the third optical measurement result for calibrating the at least one sensor of the second vehicle 112. That is to say, the apparatus 130 may calibrate the at least one sensor of the second vehicle 112 based on the first, the second and the third optical measurement results, thereby improving the accuracy of calibration for mobile optical measurements. In some embodiments, measurement results from multiple vehicles may be exploited for calibration, to make it possible to determine a condition of the road 100 more reliably.

In some embodiments, the apparatus 130 may determine a difference between a time of the first optical measurement result and a time of the second optical measurement result and/or a difference between the first optical measurement result and the second optical measurement result. If the difference between the time of the first optical measurement result and the time of the second optical measurement result is above a first threshold and/or the difference between a value of the first optical measurement result and a value of the second optical measurement result is above the second threshold, the apparatus 130 may dispose the second optical measurement result, i.e., not calibrate the at least one sensor of the second vehicle 112 based on the first and the second measurement result.

The first threshold may depend on a surface of the road 100. For example, if there is snow on the road 100, the first threshold may be lower, i.e., less time may be allowed between the time of the first optical measurement result and the time of the second optical measurement result. In general, the goal is that the conditions of the measured point, such as the location 102, are stable between the time of the first optical measurement result and the time of the second optical measurement result. In some embodiments, weather information may be considered as well, e.g., if the weather information indicates that the weather has changed substantially between the time of the first optical measurement result and the time of the second optical measurement result, it may be determined that first optical measurement result is not usable as a reference for the second optical measurement result. That is to say, if weather information indicates rapid changes, the first threshold may be set lower.

For instance, the first threshold may be 15 minutes and the second threshold may be 30%. So if two vehicles measure the same location, such as the first location 102, of road 100 within 15 minutes, the first optical measurement may be used for calibrating the at least one sensor of the second vehicle 112 if the difference between the first and the second measurements is not too large, i.e., less than 30%. Thus, reliable calibration for mobile optical measurements of road surfaces may be performed. However, if the difference between the first optical measurement and the second optical measurement is too large (above the second threshold), the second optical measurement may be rejected, i.e., disposed, to enable reliable calibration for mobile optical measurements of road surfaces, even if the difference between the time of the first optical measurement result and the time of the second optical measurement result would be below the first threshold.

That is to say, if the difference between the time of the first optical measurement result and the time of the second optical measurement result is below the first threshold and the difference between the value of the first optical measurement result and the value of the second optical measurement result is below the second threshold as well, the apparatus 130 may calibrate the at least one sensor of the second vehicle 112 based on the first optical measurement result.

Alternatively, or in addition, the apparatus 130 may determine that the background of the road 100 associated with the first optical measurement result and the background of the road 100 associated with the second optical measurement result are different. For instance, the background of the road 100 associated with the first optical measurement result may indicate black asphalt while the background of the road 100 associated with the second optical measurement result may indicate white asphalt. As both, the first optical measurement result and the second optical measurement result are associated with the same location, such as the first location 102, the different backgrounds indicate a significant error in at least one of the first and the second optical measurement results.

Hence, the apparatus 130 may dispose the second optical measurement result upon determining that the background of the road 100 associated with the first optical measurement result and the background of the road 100 associated with the second optical measurement result are different. Reliability of calibration may be therefore ensured for mobile optical measurements of road surfaces.

In some embodiments, weather may be taken into account. The apparatus 130 may receive weather information, such as a temperature or humidity. Weather information may also comprise a type of the weather, such as sunny, foggy, or rainy. Weather information may be associated with a location and a time.

For instance, the apparatus 130 may determine weather information associated with the first location 102 at a time of the first optical measurement result associated with the first location 102. In addition, the apparatus 130 may determine weather information associated with the first location 102 at a time of the second optical measurement result associated with the first location 102. The apparatus 130 may also determine a difference between said weather information associated with the first location 102 at a time of the first optical measurement result associated with the first location 102 and said weather information associated with the first location 102 at a time of the second optical measurement result associated with the first location 102. Thus, the apparatus 130 may calibrate the at least one sensor of the second vehicle 112 based at least partially on the determined difference between said weather information associated with the first location 102 at a time of the first optical measurement result associated with the first location 102 and said weather information associated with the first location 102 at a time of the second optical measurement result associated with the first location 102.

In some embodiments, the apparatus 130 may receive, from at least one weather station, said weather information associated with the first location 102 at a time of the first optical measurement result associated with the first location 102 and said weather information associated with the first location 102 at a time of the second optical measurement result associated with the first location 102. The apparatus 130 may then determine, based on the received weather information, the difference between said weather information associated with the first location 102 at a time of the first optical measurement result associated with the first location 102 and said weather information associated with the first location 102 at a time of the second optical measurement result associated with the first location 102.

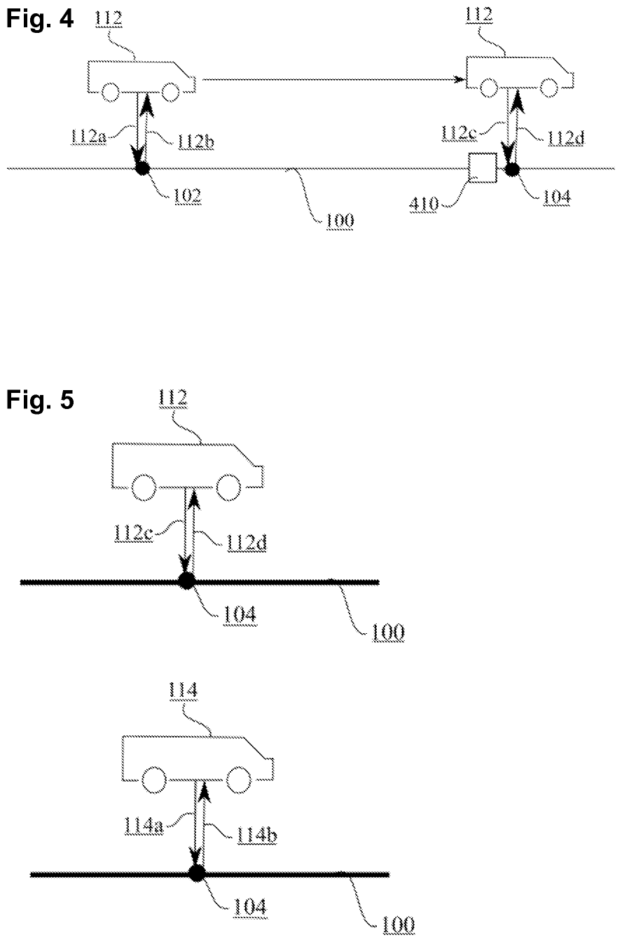

FIG. 4 illustrates a third exemplary scenario in accordance with at least some embodiments. The third exemplary scenario of FIG. 4 illustrates an embodiment, wherein the at least one sensor of the second vehicle 112 may be used for calibration at the second location 104, upon calibration of the at least one sensor of the second vehicle 112 at the first location 102 by the apparatus 130 of FIG. 1. That is to say, calibration reference may be essentially transferred from the first location 102 to the second location 104. In general, the second location 104 may refer to a point on the road 100 or a segment on the road 100, similarly as the first location 102.

FIG. 4 also shows a reference measurement device 410, such as a road weather station. The reference measurement device 410 may be, for example a, temperature sensor embedded in asphalt to directly measure the temperature of the surface of the road 100 for calibrating indirect sensors like infrared temperature measurement sensors in the second vehicle 112. In some embodiments, the apparatus 130 may comprise the reference measurement device 410. On the other hand, in some embodiments, the apparatus 130 and reference measurement device 410 may be separate devices and communicate with each other.

The second vehicle 112 may move from the first location 102 to the second location 104 after said calibration. At the second location 104, the second vehicle 112 may again perform optical measurements to generate a first optical measurement result associated with the second location 104. The first optical measurement result associated with the second location 104 may be transmitted to the apparatus 130 for example via the mobile terminal of the second vehicle 112 and the BS 120. At the second location 104, measuring may comprise transmitting a measurement signal 112c and receiving a reflected version 112d of the measurement signal.

Upon receiving the first optical measurement result associated with the second location 104, the apparatus 130 may determine that the first optical measurement result associated with the second location 104 may be used as a reference value for the second location 104. For instance, the apparatus 130 may determine that the first optical measurement result associated with the second location 104 was taken under known conditions and the at least one sensor of the second vehicle 112 has been calibrated at the first location 102 already. Additionally, in some embodiments, the apparatus 130 may determine that a time between the calibration of the at least one sensor of the second vehicle 112 at the first location 102 and a time of the first optical measurement result associated with the second location 104 is below a third threshold.

The apparatus 130 may for example determine that the time between the calibration of the at least one sensor of the second vehicle 112 at the first location 102 and the time of the first optical measurement result associated with second location 104 is less than an hour, i.e., the third threshold may be set as an hour. So if the second vehicle 112 has moved from the first location 102 to the second location 104 within an hour, the first optical measurement result associated with the second location 104 may be considered as the reference value for the second location 104.

In some embodiments, the apparatus 130 may calibrate the reference measurement device 410, e.g., by determining a difference between the first optical measurement result associated with the second location 104 and a measurement of the reference measurement device 410. So if additional, subsequent measurement results associated with the second location 104 are received, the apparatus 130 may adjust said additional, subsequent measurement results by the difference between the first optical measurement result associated with the second location 104 and the measurement of the reference measurement device 410.

FIG. 5 illustrates a fourth exemplary scenario in accordance with at least some embodiments. FIG. 5 demonstrates an embodiment, wherein the apparatus 130 has determined that the first optical measurement result associated with the second location 104, received from the at least one sensor of the second vehicle 112, may be used as the reference value for the second location 104 similarly as the first optical measurement, received from the at least one sensor of the first vehicle 110, may be used as the reference value for the first location 102 in the third exemplary scenario in FIG. 4. In FIG. 4, the fourth vehicle 114 may be similar to the first vehicle 110, i.e., the fourth vehicle 114 may comprise for example at least one sensor, such as an optical sensor capable of performing optical measurements, and a mobile terminal.

At some point, the fourth vehicle 114 may arrive to the second location 104. At the second location 104, the fourth vehicle 114 may perform optical measurements to generate a second optical measurement result associated with the second location 104. The second optical measurement result associated with the second location 104 may be transmitted to the apparatus 130 for example via the mobile terminal of the fourth vehicle 114 and the BS 120. In case of the fourth vehicle 114, measuring may comprise transmitting the measurement signal 114a at the second location 104 and receiving reflected version of the measurement signal 114b.

Thus, the apparatus 130 may calibrate the at least one sensor of the fourth vehicle 114, e.g., by determining a difference between the first and the second optical measurement results associated with the second location 104. So if additional, subsequent measurement results associated with the second location 104 are received from the at least one sensor of the fourth vehicle 114, the apparatus 130 may adjust said additional, subsequent measurement results by the difference between the first and the second optical measurement results associated with the second location 104.

For instance, the at least one sensor of the fourth vehicle 114 may be calibrated based on the determined background of the road 100 at the second location 104. Alternatively, or in addition, the apparatus 130 may calibrate the at least one sensor of the fourth vehicle 114 based on the determined road surface classification of the road 100 at second location 104. In general, the calibration of the at least one sensor of the fourth vehicle 114 may be performed similarly as the calibration of the at least one sensor of the second vehicle 112 at the first location 102.

With reference to FIG. 4 again, in some embodiments, the apparatus 130 may calibrate the at least one sensor of the fourth vehicle 114, e.g., by determining a difference between the second optical measurement result associated with the second location 104, received from the fourth vehicle 114, and a measurement result received from the reference measurement device 410. Alternatively, the apparatus 130 may calibrate the at least one sensor of the fourth vehicle 114 based on the measurement result of the reference measurement device 410 upon calibrating the reference measurement device 410 based on the first optical measurement result associated with the second location 104, received from the second vehicle 112.

A condition for calibrating the at least one sensor of the fourth vehicle 114 based on the measurement result of the reference measurement device 410 may be related to a time between taking the second optical measurement result associated with the second location 104 and a time of calibration of the reference measurement device 410. That is to say, the time between taking the second optical measurement result associated with the second location 104 and the time of calibration of the reference measurement device 410 may not exceed a fourth threshold, such as 1 day. It may be assumed that the reference measurement device 410 may not need to be calibrated as often as sensors of vehicles and thus, the fourth threshold may be larger than for example the third threshold.

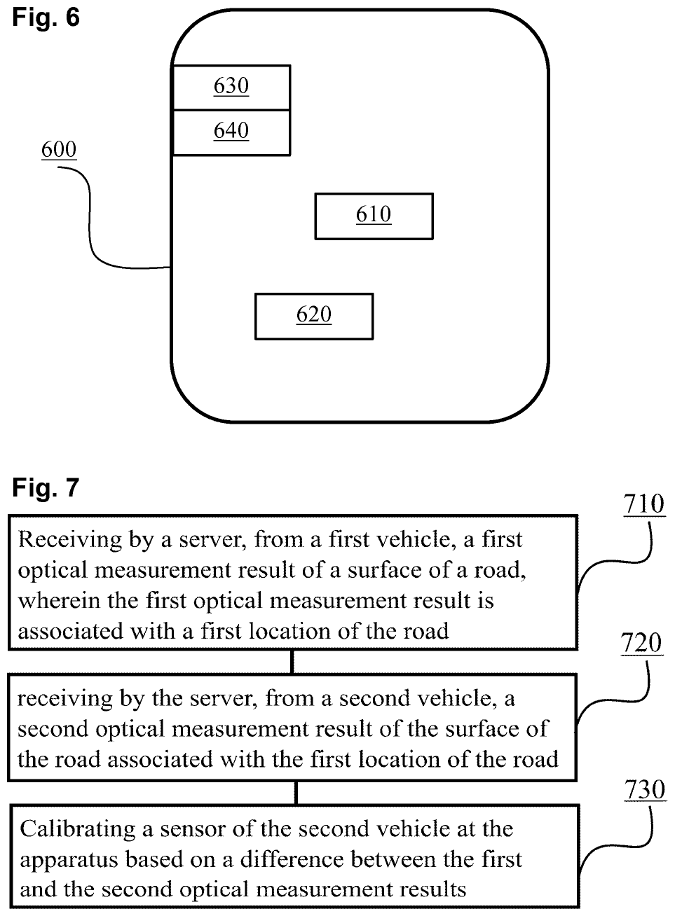

FIG. 6 illustrates an example apparatus capable of supporting at least some embodiments. Illustrated is an apparatus 600, which may comprise, for example, the apparatus 130 of FIG. 1. Comprised in the apparatus 600 of FIG. 6 is a processing unit 610, which may comprise, for example, a single- or multi-core processor wherein a single-core processor comprises one processing core and a multi-core processor comprises more than one processing core. The processing unit 610 may comprise, in general, a control apparatus. The processing unit 610 may comprise more than one processor. The processing unit 610 may be a control apparatus. The processing unit 610 may be configured, at least in part by computer instructions, to perform actions.

The apparatus 600 of FIG. 6 may comprise a memory 620. The memory 620 may comprise Random-Access Memory, RAM, and/or permanent memory. The memory 620 may comprise at least one RAM chip. The memory 620 may comprise solid-state, magnetic, optical and/or holographic memory, for example. The memory 620 may be at least in part accessible to the processing unit 610. The memory 620 may be at least in part comprised in the processing unit 610. The memory 620 may be means for storing information. The memory 620 may comprise computer instructions that the processing unit 610 is configured to execute. When computer instructions configured to cause the processing unit 610 to perform certain actions are stored in the memory 620, and the apparatus 600 of FIG. 6 overall is configured to run under the direction of processing unit 610 using computer instructions from the memory 620, the processing unit 610 and/or its at least one processing core may be considered to be configured to perform said certain actions. The memory 620 may be at least in part comprised in the processing unit 610. The memory 620 may be at least in part external to the apparatus 600 but accessible to the apparatus 600.

The apparatus 600 may comprise a transmitter 630. The apparatus 600 may comprise a receiver 640. The transmitter 630 may comprise more than one transmitter. The receiver 640 may comprise more than one receiver. The transmitter 630 and the receiver 640 may be configured to transmit and receive, respectively, information over air interface and/or wired interface.

The processing unit 610 may be furnished with a transmitter arranged to output information from the processing unit 610, via electrical leads internal to apparatus 600, to other devices comprised in the apparatus 600 of FIG. 6. Such a transmitter may comprise a serial bus transmitter arranged to, for example, output information via at least one electrical lead to the memory 620 for storage therein. Alternatively to a serial bus, the transmitter may comprise a parallel bus transmitter. Likewise, the processing unit 610 may comprise a receiver arranged to receive information in the processing unit 610, via electrical leads internal to apparatus 600, from other devices comprised in apparatus 600. Such a receiver may comprise a serial bus receiver arranged to, for example, receive information via at least one electrical lead from the receiver 640 for processing in the processing unit 610. Alternatively to a serial bus, the receiver may comprise a parallel bus receiver.

The processing unit 610, memory 620, transmitter 630 and receiver 640 may be interconnected by electrical leads internal to apparatus 600 in a multitude of different ways. For example, each of the aforementioned devices may be separately connected to a master bus internal to the apparatus 600 of FIG. 6, to allow for the devices to exchange information. However, as the skilled person will appreciate, this is only one example and depending on the embodiment various ways of interconnecting at least two of the aforementioned devices may be selected without departing from the scope of the embodiments.

FIG. 7 is a flow graph of a method in accordance with at least some embodiments. The phases of the illustrated first method may be performed by the apparatus 130 by a control apparatus configured to control the functioning thereof, possibly when installed therein. The phases of the first method may be suitable for a conditional handover.

The method may comprise, at step 710, receiving from a first vehicle a first optical measurement result of a surface of a road, wherein the first optical measurement result is associated with a first location of the road. The method may also comprise, at step 720, receiving from a second vehicle a second optical measurement result of the surface of the road associated with the first location of the road. Finally, the method may comprise, at step 730, calibrating a sensor of the second vehicle at a server based on a difference between the first and the second optical measurement results associated with the first location of the road.

It is to be understood that the embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples may be referred to herein along with alternatives for the various components thereof. It is understood that such embodiments, examples, and alternatives are not to be construed as de facto equivalents of one another but are to be considered as separate and autonomous representations.

An apparatus, such as, for example, the apparatus 130, or a control apparatus configured to control the functioning thereof, may comprise means for carrying out the embodiments described above and any combination thereof.

A computer program may be configured to cause a method in accordance with the embodiments described above and any combination thereof. A computer program product, embodied on a non-transitory computer readable medium, may be configured to control a processor to perform a process comprising the embodiments described above and any combination thereof.

An apparatus, such as, e.g., the apparatus 130, or a control apparatus configured to control the functioning thereof, may comprise at least one processor, and at least one memory including computer program code, wherein the at least one memory and the computer program code are configured to, with the at least one processor, cause the apparatus at least to perform the embodiments described above and any combination thereof.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the present disclosure. One skilled in the relevant art will recognize, however, that the aspects of the disclosed embodiments can be practiced without one or more of the specific details, or with other methods, components, materials, etc. In other instances, well-known structures, materials, or operations are not shown or described in detail to avoid obscuring aspects of the disclosed embodiments.

While the forgoing examples are illustrative of the principles of the embodiments in one or more particular applications, it will be apparent to those of ordinary skill in the art that numerous modifications in form, usage and details of implementation can be made without the exercise of inventive faculty, and without departing from the principles and concepts of the. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments find industrial application in road surface monitoring. For instance, at least some embodiments may be exploited for calibration of mobile road measurements.

### Abbreviations

### BS Base Station

GSM Global System for Mobile communication

### IoT Internet of Things

### LED Light-Emitting Diode

### LTE Long-Term Evolution

### M2M Machine-to-Machine

### SWIR Short-Wave Infrared

### WLAN Wireless Local Area Network

### WiMAX Worldwide Interoperability for Microwave Access

### REFERENCE SIGNS LIST

100 Road
102, 104 Locations on road 100
110, 112, 114 Vehicles
110a-b, 112a-d, 114a-b Signals
120 Base Station
115, 125 Interfaces
130 Apparatus, e.g., a server
200 Road surface
210 Layer of water
410 Reference measurement device
600-640 Structure of the apparatus of FIG. 6
710-730 Phases of the first method in FIG. 7

1. An apparatus, comprising:
a receiver configured to receive from a first vehicle a first optical measurement result, and to receive from a second vehicle a second optical measurement result; and
at least one processor configured to calibrate a sensor of the second vehicle at the apparatus based on a difference between the first and the second optical measurement results; wherein:
the first optical measurement result is an optical measurement result of a surface of a road associated with a first location of the road;
the second optical measurement result is an optical measurement result of the surface of the road associated with the first location of the road; and
the at least one processor is further configured to determine a background of the road at the first location based on the first optical measurement result associated with the first location of the road and calibrate the sensor of the second vehicle based at least partially on the determined background of the road at the first location.

2. The apparatus according to claim 1, wherein:
the receiver is further configured to receive from a third vehicle a third optical measurement result of a surface of the road associated with the first location of the road, and to receive from a fourth vehicle a fourth optical measurement result of the road associated with the first location of the road;
the first optical measurement result comprises measurement data of a first set of wavelengths;
the second optical measurement result comprises measurement data of the first set of wavelengths;
the third optical measurement result comprises measurement data of a second set of wavelengths;
the fourth optical measurement result comprises measurement data of the second set of wavelengths;
the at least one processor is further configured to compare the first measurement result with the second measurement result and to calibrate the sensor of the second vehicle accordingly; and
the at least one processor is further configured to compare the third measurement result with the fourth measurement result and to calibrate the sensor of the fourth vehicle accordingly;
wherein the second vehicle may be the third vehicle; and the order of the first, second, third and fourth vehicles may be ascending or descending.

3. The apparatus according to claim 1, wherein the at least one processor is further configured to determine that the first optical measurement result associated with the first location of the road has been taken at known conditions of the surface of the road at the first location and set, responsive to the determination, the first optical measurement result associated with the first location of the road as a reference measurement result of the first location.

4. The apparatus according to claim 1, wherein the at least one processor is further configured to determine a road surface classification of the first optical measurement result associated with the first location and calibrate the sensor of the second vehicle based at least partially on the road surface classification of the first optical measurement result associated with the first location.

5. The apparatus according to claim 1, wherein the at least one processor is further configured to determine a difference between a road surface classification of the first optical measurement result associated with the first location and a road surface classification of the second optical measurement associated with the first location, and calibrate the sensor of the second vehicle based at least partially on the difference between the road surface classification of the first optical measurement result associated with the first location and the road surface classification of the second optical measurement result associated with the first location.

6. The apparatus according to claim 1, wherein the receiver is further configured to receive, from a third vehicle, a third optical measurement result associated with the first location and the at least one processor is further configured to calibrate the sensor of the second vehicle based at least partially on the first, the second and the third optical measurement results associated with the first location.

7. The apparatus according claim 6, wherein the at least one processor is further configured to determine a difference between a road surface classification of the first optical measurement result associated with the first location and a road surface classification of the third optical measurement result associated with the first location and calibrate the sensor of the second vehicle by compensating for the difference between the road surface classification of the first optical measurement result associated with the first location and the road surface classification of the third optical measurement result associated with the first location.

8. The apparatus according to claim 7, wherein the road surface classification of the first optical measurement result is dry and the road surface classification of the third optical measurement result is wet.

9. The apparatus according to claim 1, wherein the at least one processor is further configured to calibrate the sensor of the second vehicle based at least partially on a difference between a weather at the first location at a time of the first optical measurement result associated with the first location and a weather at the first location at a time of the second optical measurement result associated with the first location.

10. The apparatus according to claim 9, wherein the receiver is further configured to receive weather information from a weather station and the at least one processor is configured to determine, based on the received weather information, the weather at the first location at a time of the first optical measurement associated with the first location and the weather at the first location at a time of the second optical measurement associated with the first location.

11. The apparatus according to claim 1, wherein the receiver is further configured to receive from the second vehicle, upon calibration of the sensor of the second vehicle, a first optical measurement result associated with a second location and to receive from a fourth vehicle a second optical measurement result associated with the second location, and the at least one processor is further configured to calibrate a sensor of the fourth vehicle based on a difference between the first and the second optical measurement results associated with the second location.

12. The apparatus according to claim 1, wherein the at least one processor is further configured to dispose the second optical measurement result upon determining that a difference between a time of the first optical measurement result and a time of the second optical measurement result is above a first threshold value, and/or a difference between a value of the first optical measurement result and a value of the second optical measurement result is above a second threshold.

13. The apparatus according to claim 1, wherein the at least one processor is further configured to dispose the second optical measurement result upon determining that a background of the road associated with the first optical measurement result and a background of the road associated with the second optical measurement result are different.

14. A method, comprising:
receiving by a server, from a first vehicle, a first optical measurement result;
receiving by the server, from a second vehicle, a second optical measurement result;
calibrating a sensor of the second vehicle at the server based on a difference between the first and the second optical measurement results associated with the first location of the road; wherein:
the first optical measurement result is a measurement of a surface of a road associated with a first location of the road;
the second optical measurement is of a measurement of the surface of the road associated with the first location of the road; and the method further comprises:
determining a background of the road at the first location based on the first optical measurement result associated with the first location of the road; and
calibrating the sensor of the second vehicle based at least partially on the determined background of the road at the first location.

15. (canceled)

16. A computer program configured to cause an apparatus to perform a method according to claim 14, when the computer program is executed by the apparatus.

17. The apparatus according to claim 2, wherein the at least one processor is further configured to determine that the first optical measurement result associated with the first location of the road has been taken at known conditions of the surface of the road at the first location and set, responsive to the determination, the first optical measurement result associated with the first location of the road as a reference measurement result of the first location.

18. The apparatus according to claim 17, wherein the at least one processor is further configured to determine a road surface classification of the first optical measurement result associated with the first location and calibrate the sensor of the second vehicle based at least partially on the road surface classification of the first optical measurement result associated with the first location.

19. The apparatus according to claim 2, wherein the at least one processor is further configured to determine a road surface classification of the first optical measurement result associated with the first location and calibrate the sensor of the second vehicle based at least partially on the road surface classification of the first optical measurement result associated with the first location.

20. The apparatus according to claim 2, wherein the at least one processor is further configured to determine a difference between a road surface classification of the first optical measurement result associated with the first location and a road surface classification of the second optical measurement associated with the first location, and calibrate the sensor of the second vehicle based at least partially on the difference between the road surface classification of the first optical measurement result associated with the first location and the road surface classification of the second optical measurement result associated with the first location.

21. The apparatus according to claim 2, wherein the receiver is further configured to receive, from a third vehicle, a third optical measurement result associated with the first location and the at least one processor is further configured to calibrate the sensor of the second vehicle based at least partially on the first, the second and the third optical measurement results associated with the first location.
